(19) United States
(12) Patent Application Publication
(10) Pub. No.: US 2006/0204661 A1
(43) Pub. Date: Sep. 14, 2006

(54) Thermal coating process and masking for it

(76) Inventors: Jens Beck, Gerstetten (DE); Torsten Wittrowski, Ulm (DE); Ansgar Zoller, Neu-Ulm (DE)

Correspondence Address: AKERMAN SENTERFITT, P.O. BOX 3188, WEST PALM BEACH, FL, 33402-3188, US

(21) Appl. No.: 11/295,227

(22) Filed: Dec. 6, 2005

(30) Foreign Application Priority Data
Dec. 6, 2004 (DE) 102004058705.1-45

(51) Int. Cl. B05D 5/00

(52) U.S. Cl. 427/282; 118/504

(57) ABSTRACT

Thermal coating processes are widely used to create localized different surface properties on work pieces, in particular enhanced hardness properties. It is important that only those regions of the work piece surface are activated and coated which have been planned for, and for this a mask is applied to the surface. The surface may be treated after application of the mask by a process such as grit blasting. The mask may be dimensionally stable for only a limited time. Removal of the coating material is possible but time and labor intensive. An improved mask is provided utilizing joined particles for the fabrication of the mask. After the coating, the used mask can be separated into its individual particles, which are then separated from the coating residues and are reused for the fabrication of new masks.

### BACKGROUND OF THE INVENTION

1. Field of the Invention

The invention relates to a thermal coating process and a mask for it. Such a process and such a mask are already disclosed in DE 199 10 577 A1.

2. Related Art of the invention

Thermal coating processes such as, for instance, plasma spraying, high speed flame spraying or electric arc spraying are well known and meanwhile widely used to create localized different surface properties on work pieces, and in particular enhanced sliding or hardness properties.

Prior to the coating process a pre-treatment, a so called activation, is usually performed, which is often done through grit blasting. Through this activation oxide layers on the work piece surface are removed and the surface is roughened which increases the surface area as well as enhances the adhesion of the coating by mechanical interlocking with the coating.

It is important that only those regions of the work piece surface are activated and coated which have been planned for. An activated but not coated surface is very susceptible to corrosion. The coating may significantly change the surface properties, thus the coating should only be deposited only in the defined regions. For this reason masks are utilized during activation and coating (compare e.g. DE 099 10 577 A1).

Usual the mask is subject to high wear during the activation process as well as being subject to adhesion of the coating material during the coating process, and it is thus dimensionally stable only for a limited time. Removal of the coating material is possible but time and cost intensive. Abrasively worn masks must be completely replaced by new ones.

### SUMMARY OF THE INVENTION

The objective of the invention is to create an alternative to the established masks and partial coating processes.

With respect to the mask, the objective is accomplished according to the invention by utilizing particles joined to each other in its fabrication.

Such a disposable mask can be quickly and cost efficiently produced in large numbers by compression molding of the particles in a negative mold.

A mask for the coating process does not need a high stability and can be produced by simple compression molding without any additional bonding agent.

A mask for the activation process requires a higher stability. Depending on the particle material, the addition of a solvent (for salt particles e.g. water) for a superficial wetting and dissolving may be sufficient to bond the particles sufficiently firmly together. Higher stabilities can be achieved by adding bonding agents.

Ideally the particles forming the mask are made from the same material which is used for the grit blasting, e.g. SiO₂, SiC or Al₂O₃, since in that case the reconditioning and recycling of the activation mask material is possible without an additional cleaning or separation step.

If the same mask is utilized for the activation and the coating, then an additional cleaning or, as the case may be, separation step is necessary to clean the mask particles from the coating residues. In this case also a grit which is different from the mask material can be used without adding significant expense.

With respect to the process the objective is accomplished according to the invention by utilizing an above described mask.

This is advantageous in terms of a simple, fast and cost efficient production of a disposable product which in addition to that can easily be reconditioned and recycled. For that, subsequent to the coating or, as the case may be, activation, the mask must be separated into its individual particles which can then be utilized for the fabrication of new masks. For this, usually a separation of the adhering coating residues is necessary.

In case that cleaning is too expensive, the mask leftovers may alternatively be reused as grit.

Particularly preferaly the mask according to the invention and the process according to the invention can be utilized for the coating of internal surfaces, especially the internal cylinder surface of internal combustion engines. Such internal surfaces are usually accessible only with difficulty. Nevertheless, only defined regions ought to be activated and coated in order to guarantee reproducible properties of the cylinders in mass production. This is only possible through an exact mask during the various process steps.

In the following two examples for embodiments of the mask according to the invention are explained in greater detail.

In a first exemplary embodiment of the invention the internal cylinder surfaces of a cylinder crank case of an internal combustion machine are coated. Their topology is known and available as CAD-data or it can be determined by a measurement. The data defining the outer rim of the internal cylinder surface and its surrounding constitute the data set of the bottom part of a torroid shaped mask. The top part of the mask is flat, the thickness of the torroid is about 5 mm to ensure sufficient stability, and the width is approximately 10 cm to protect the cylinder crank case from activation and coating.

From such a data set two half-shell negative molds are fabricated, e.g. by milling from a solid.

The mask is fabricated by filling the negative mold with moisturized sand which is mixed with the bonding agent bentonite. The filled negative form is then closed under the conventional pressure measured in bar and the mask is pressure molded. Subsequently it can be taken out and precisely fitted onto the cylinder liner.

Subsequent to the coating the mask can be removed from the cylinder liner by knocking or shaking and then crushed fine enough so that the mask particles can be separated from the coating residues. After the crushing the separation can be done with conventional methods like density separation. The separated mask particles can then be used for the fabrication of new masks.

In a second exemplary embodiment an activation mask is produced and only used during activation of the surface.

The negative form is fabricated as described above. The activation mask is formed from SiC particles which are mixed with a bonding agent and pressure molded. The activation is also performed with SiC particles.

After the activation the mask is removed and crushed. A separation is not necessary in this case since mask and grit consist of the same material.

The process according to the invention and the mask according to the invention in the embodiments described above have proven to be particularly suitable for the thermal coating of the internal surfaces of cylinders especially in the automotive industry.

Through its use significant advantages with respect to reproducibility of the coating can be achieved. Also the mass production of large numbers of identical disposable masks from reusable particles is more cost efficient than the repeated cleaning and continuous wear control of reusable masks according to the state of the art.

The invention is not limited to the above mentioned embodiments but rather has broad applications.

It is for instance also possible to fabricate the masks by pressure molding with water wetted salt particles, and to simply dissolve the salt in water for cleaning after use.

1. A mask for a thermal coating process, wherein said mask is constituted by particles which are joined to each other.

2. A mask according to claim 1, wherein said mask is constituted by pressure molded sand or salt particles.

3. A mask according to claim 1, wherein said mask is constituted by wetted particles.

4. A process for partial thermal coating in which part of a work piece which is to be coated is covered by a mask constituted by particles which are joined to each other.

5. A process according to claim 4, wherein subsequent to the coating the mask is removed from the work piece and separated into its individual particles.

6. A process according to claim 5, wherein the recycled particles are utilized to fabricate new masks.

7. A process according to claim 5, wherein the recycled particles are separated from coating residues.

8. A mask according to claim 1, wherein said mask is free of solvent and bonding agent.

9. A mask according to claim 1, wherein said particles forming said mask are joined using a solvent or bonding agent.

10. A process according to claim 4, wherein said mask is free of solvent and bonding agent.

11. A process according to claim 4, wherein said particles forming said mask are joined using a solvent or bonding agent.

12. A process according to claim 4, wherein after application of the mask said work piece is grit blasted with particles of the same composition as the particles constituting the mask.
